(19) United States
(12) Patent Application Publication
(10) Pub. No.: US 2016/0266866 A1
(43) Pub. Date: Sep. 15, 2016

(54) Music streaming from TV to stereo

(71) Applicant: Michael Lewis Moravitz, Fairfax, VA (US)

(72) Inventor: Michael Lewis Moravitz, Fairfax, VA (US)

(21) Appl. No.: 14/999,274

(22) Filed: Apr. 18, 2016

(51) Int. Cl. G06F 3/16

(52) U.S. Cl. CPC G06F 3/165

(57) ABSTRACT

Digitized music may be streamed, like video, and link through a high-speed cable with an integrated system in which memory would hold the music in a sound system with speakers. This sound system could have a USB port for IPods and other MP3 players.

Digitized music may be streamed, like video, and link through a high-speed cable with an integrated system in which memory would hold the music in a sound system with speakers.

This sound system could have a USB port for IPods and other MP3 players. This would create an integrated home entertainment system, with both video and sound applications. Streaming services such as Netflix and digitized music providers such as ITunes might create music streaming services linking not only the television but to a home sound system that could save the music on memory, including from MP3 players through the USB port. The customers then could play the music on home speakers, which might be integrated into the television system as well for better video sound. Music might be purchased just as video is now purchased or rented through streaming services or cable and satellite television providers. The music might also be transferred to one's MP3 player through the USB port. The miniaturization of computer memory makes this possible. Perhaps one large Digital Video/Music System would contain enough memory for both applications. This patent application breaks through compatibility issues and allow customers a choice on how to access music, which could potentially come only from a high-speed television system, including cable and satellite. DVD and CD players might be included through proper connections in the integrated system. Standardization of USB and other cables and port systems makes this possible among different manufacturers of different components, including other MP3 players than the IPod. Cover art, track listings, and liner notes might be provided to view on screen along with the music. This application would also be applicable to podcasts, concert films, and audio books.

1) Builds on Video Streaming Services such as Netflix;

2) Digitized Music providers such as ITunes;

3) Previous Patent Application for Integrated Home Systems with MP3 (Ser. No. 14/998,584; Filing Date Mar. 12, 2014); and

4) Previous Patent Application for Home Sound System with MP3 USB (Port).
